(19) United States
(12) Patent Application Publication
(10) Pub. No.: US 2007/0162231 A1
(43) Pub. Date: Jul. 12, 2007

(54) Sensor system for detecting a pedestrian collision

(76) Inventor: Michael Schlogl, Budingen-Aulendiebach (DE)

Correspondence Address: Martin A Farber, 866 United Nations Plaza, New York, NY, 10017, US

(21) Appl. No.: 10/559,955

(22) PCT Filed: Aug. 29, 2005
(86) PCT No.: PCT/EP05/54236

§ 371 Date: May 18, 2006

(30) Foreign Application Priority Data
Nov. 9, 2004 (DE) 10 2004 054 072.1

(51) Int. Cl. G08G 1/16; G06F 19/00

(52) U.S. Cl. 701/301

(57) ABSTRACT

The invention relates to a sensor system for detecting a pedestrian collision in the front region of a motor vehicle, having at least one fiber optic sensor that extends in the front region of the motor vehicle largely over the entire vehicle width and can be deformed by the collision of an object in the front region, a signal being generated by the fiber optic sensor owing to the collision of the object. In order to specify a sensor system for detecting a pedestrian collision in the front region of a motor vehicle having at least one fiber optic sensor that enables a reliable distinction between the collision of animate and inanimate objects, there is arranged in the front region of the motor vehicle in addition to the fiber optic sensor at least one infrared sensor that generates a signal for distinguishing between the collision of animate and inanimate objects.

The invention relates to a sensor system for detecting a pedestrian collision in the front region of a motor vehicle, having at least one fiber optic sensor that extends in the front region of the motor vehicle largely over the entire vehicle width and can be deformed by the collision of an object in the front region, a signal being generated by the fiber optic sensor owing to the collision of the object.

Motor vehicle manufacturers are faced with the task of optimizing newly developed vehicles in such a way that pedestrians who are caught frontally by the vehicle in the event of an accident suffer injuries that are as slight as possible. It has proved in this regard that the engine hood of motor vehicles, which is arranged in the front region, is very well suited to absorb the collision of a pedestrian and to minimize the forces acting on the pedestrian in that the engine hood yields correspondingly on impact by the pedestrian. However, with modern motor vehicles the density with which the assemblies are integrated in the engine compartment is so high that there is scarcely room remaining under the engine hood for the mostly very hard assemblies in the engine compartment. Thus, for example, the upper body of the pedestrian involved in the accident can, for example, impact the engine hood, the latter being deformed and yielding, but the deformation path is mostly very limited, since located only a very few centimeters underneath the engine hood is the cylinder head of the internal combustion engine of the motor vehicle, and it is so hard that the pedestrian involved in the accident is dealt extremely severe injuries. In order to counteract this, engine hoods have been developed that in the event of a frontal accident involving a pedestrian are released from their normal installed position and raised above this installed position by approximately 10 to 15 cm. This results between the raised engine hood and the assemblies in the engine compartment in a type of crush zone that has the effect that the pedestrian involved in the accident does not directly impact the very hard assembly. In order to implement such a raising of the engine hood in the event of an accident, it is necessary to provide sensors that firstly can quickly and reliably detect the frontal impact of an object and can, moreover, distinguish whether the object hit is a pedestrian or an inanimate object. If a pedestrian is involved in the accident, the engine hood is to be released from its normal installed position and raised a few centimeters in order to spare the pedestrian. If, however, it is a matter of a collision with an inanimate object, the engine hood is not to be released from its normal installed position under any circumstances, because it is to serve as an energy-absorbing component for protecting the vehicle occupants.

DE 102 56 950 A1 discloses a pedestrian protection system and a method for protecting pedestrians. Specified here is an optical sensor for a motor vehicle that is installed in the front region of a motor vehicle. The fiber optic sensor comprises a light source and detectors as well as two optical fibers that transport light generated by the light source and pass it on to the detectors. The two optical fibers are arranged in a carrier material. In this case, one optical fiber is equipped with a sensitive area, while the other optical fiber is not provided with a sensitive area. If light is now coupled from a light source at one end of the fiber, the light is guided through the optical fiber and finally reaches the other end of the optical fiber with a residual intensity. The residual light intensity can be measured there by a detector. If the sensitive area of the fiber optic sensor is deformed, for example owing to the impact of an object, this exerts an influence on the light intensity emerging in this area, and thus also on the intensity detected by the detector.

Where use is made of fiber optic sensors, the aim is to use complicated software solutions that are executed in the evaluation unit of the fiber optic sensor in order to distinguish whether the object that has collided in the front region is an animate or inanimate object. As already described at the beginning, this decision is enormously important as to whether the engine hood is to be released from its original installed position and raised, or whether it is to remain in its original anchorage. This decision between animate and inanimate objects in the case of an accident is extremely difficult, and also cannot yet be satisfactorily solved with complicated programs.

It is therefore the object of the present invention to specify a sensor system for detecting a pedestrian collision in the front region of a motor vehicle with the aid of at least one fiber optic sensor, and that enables a reliable distinction between the collision of animate and inanimate objects.

The object is achieved according to the invention by virtue of the fact that in addition to the fiber optic sensor, there is arranged in the front region of the motor vehicle at least one infrared sensor that generates a signal for distinguishing between the collision of animate and inanimate objects.

The invention has the advantage that there is now available a signal with the aid of which it can be distinguished unambiguously and very quickly whether the motor vehicle has collided with an animate or inanimate object. Owing to the inventive use of the infrared sensor in combination with the fiber optic sensor, complicated computer programs and their associated hardware that are intended to achieve a distinction between collisions of an animate object and an inanimate object with the aid of a characteristic change in the transmission of light through the fiber optic sensor are no longer required. In one refinement of the invention, the fiber optic sensor is integrated in the front fender of the motor vehicle. Parts of the fender can be fashioned such that they can easily be deformed upon the collision of an object, as a result of which the fiber optic sensor is also suitably deformed in the case of an accident in order to generate its signal in an optimum fashion.

In a next refinement, the infrared sensor is also integrated in the front fender of the motor vehicle. In this position, the infrared sensor detects the object earliest, and so distinction between animate and inanimate objects can be made at an early stage.

In one development, the signals of the fiber optic sensor and of the infrared sensor are evaluated by a control unit. The available information relating to the type of accident is assembled and evaluated in this control unit. In the process, the control unit decides whether the engine hood is to be raised from its original installed position. This decision can be made quickly and reliably in the control unit.

In a next development, the control unit is also fed signals from a temperature sensor that are evaluated in the control unit in addition to the signals of the fiber optic sensor and of the infrared sensor. The infrared sensor can thereby be calibrated through the respective ambient temperature, and this also enables a yet more accurate distinction between animate and inanimate objects.

It is, furthermore, advantageous when the control unit is also fed signals from a tachometer that are evaluated in the control unit in addition to the signals of the fiber optic sensor, of the infrared sensor and of the temperature sensor. The additional information relating to the vehicle speed can also be an important variable for deciding on raising the engine hood.

The invention permits numerous designs. One of these is explained by way of example with the aid of the figures in which:

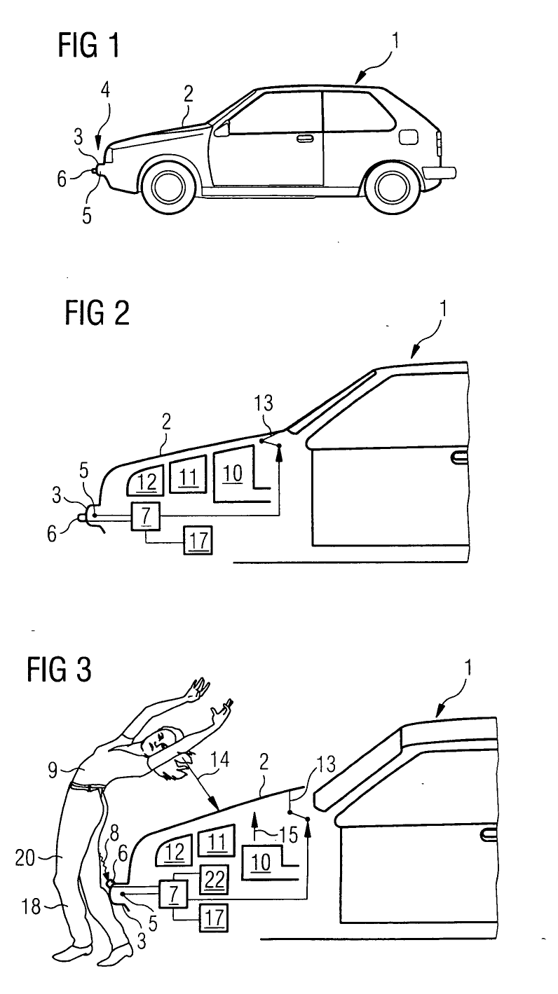

FIG. 1 shows a motor vehicle with an engine hood and a fender,

FIG. 2 shows a lateral section through the engine compartment of the motor vehicle,

FIG. 3 shows an accident situation with a person,

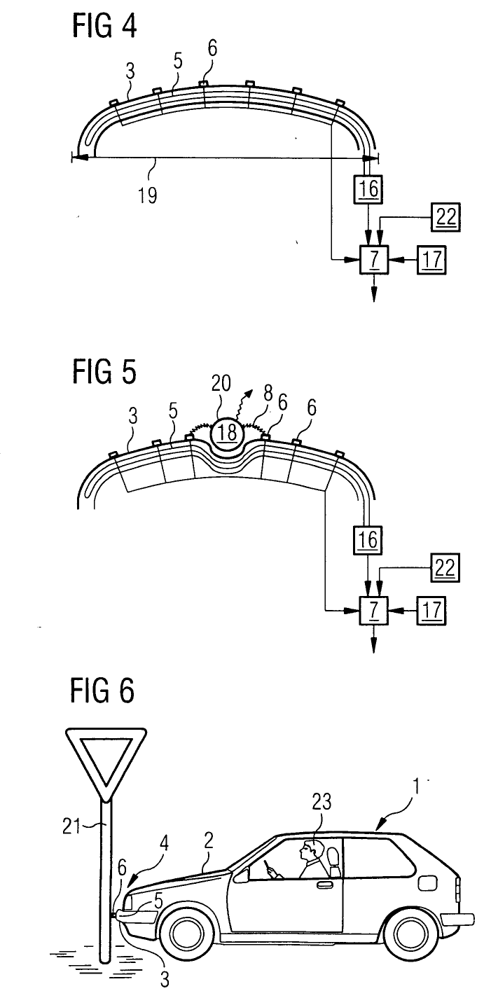

FIG. 4 shows a fender with a fiber optic sensor,

FIG. 5 shows an accident situation with an animate object, and

FIG. 6 shows an accident situation with an inanimate object.

FIG. 1 shows a motor vehicle 1 with an engine hood 2 and a fender 3. The fender 3 is arranged in the front region 4 of the motor vehicle and includes a fiber optic sensor 5. An infrared sensor 6 is also arranged on the fender 3.

A lateral section through the engine compartment of the motor vehicle 1 is shown in FIG. 2. Once again, the engine hood 2 and the fender 3 are to be seen. Located in the engine compartment beneath the engine hood 2 are the engine block 10, a first subassembly 11 and a second subassembly 12. The engine hood 2 is produced as a rule from thin and yielding sheet steel that can entirely advantageously absorb the impact of a person 9 involved in the accident. However, it is clearly illustrated in FIG. 2 that assemblies 10, 11, 12 that are produced as a rule from very hard and unyielding material are located beneath the engine hood 2 of the motor vehicle 1 at a high integration density. For example, the engine block 10 is arranged as a rule only a few centimeters beneath the engine hood 2 and so a person 9 involved in the accident who impacts the engine hood 2 can suffer severe injuries. In order to prevent this, there is arranged in the fender 3 a fiber optic sensor 5 that can detect the impact of an object. However, it is problematical to use this fiber optic sensor 5 to decide whether an animate object 20 or an inanimate object 21 has been hit by the vehicle. Programs can be run in the control unit 7 that use the deformation characteristic of the fiber optic sensor 5 and the characteristic change in intensity, resulting therefrom, for the light transmitted by the fiber to enable a distinction between animate objects 20 and inanimate objects 21. However, this distinction is not made in an entirely satisfactory fashion and, as a rule, the programs require a long computing time and a relatively high computing power before it is possible to distinguish between animate and inanimate colliding objects. Consequently, there is placed in the front region 4 of the motor vehicle 1 an infrared sensor 6 that uses infrared radiation 8 emitted by the object hit to detect whether the opposite number in the accident is an animate object 20 or an inanimate object 21. All this information is fed to the control unit 7, which decides whether the engine hood lifting mechanism 13 is to be activated or not. Moreover, the control unit 7 is supplied by a temperature sensor 17 with information relating to the current ambient temperature, as a result of which the infrared sensor 6 can be calibrated. In winter, for example at low ambient temperatures, a person 9 can be wearing warm clothing, and so the infrared spectrum emanating from the person 9 differs from that in summer at high ambient temperatures when the person 9 is wearing light clothing. In accordance with these circumstances, the signal of the infrared sensor 6 can be evaluated in the control unit 7 when the temperature sensor 17 makes available an item of information relating to the current ambient temperature. The signal of a tachometer 22 can also be fed to the control unit 7 in addition, in order to support the decision to raise the engine hood 2 with further information.

An accident situation with a person 9 is illustrated in FIG. 3. Here, the person 9 is caught frontally by the motor vehicle 1. The leg 18 of the person 9 deforms the fender 3, in which case the fiber optic sensor 5 arranged therein is also deformed and then sends a corresponding signal to the control unit 7. Since the person 9 is an animate object 20, the characteristic infrared radiation 8 is sent to the infrared sensor 6 placed here on the fender 3. The signals of the infrared sensor 6 are evaluated in the control unit 7 and, if necessary, calibrated with the ambient temperature supplied by the temperature sensor 17. The control unit 17 uses all this information to calculate the decision that the engine hood 2 is to be raised, since an animate object 20 has been hit. The engine hood lifting mechanism 15 is illustrated in FIG. 3 by an arrow. The engine hood is raised with the aid of at least one engine hood lifting mechanism 13 such as has been described, for example, in DE 102 56 950 A1. The person 9 hit moves in the impacting direction 14 toward the engine hood 2 which, because of having been raised, has now moved approximately 15 to 50 cm away from the engine block 10 and the first subassembly 11 and the second subassembly 12. Since the engine hood 2 consists of thin sheet which can be effectively deformed, the person 9 hit is intercepted by the raised engine hood 2 in a relatively gentle fashion, thus substantially reducing the risk of injury. An accident situation with an inanimate object 21 will be illustrated later in FIG. 6 and explained.

FIG. 4 shows a fender 3 in which at least one further optic sensor 5 is integrated. This fiber optic sensor 5 consists of light guiding fibers into which there is coupled from the optocoupler 16 light that is transported through the fiber optic sensor 5 and is then read out again in the optocoupler 16, generally by photodiodes. The light intensity transported to the fiber optic sensor 5 is a measure of the position and the degree of deformation of the fiber optic sensor 5. The fiber optic sensor 5 is shown in FIG. 4 in its predetermined installed position (without the presence of a deformation). A specific constant light intensity is measured in the optocoupler 16. The fiber optic sensor 5 extends virtually over the entire vehicle width 19. The intensity information from the optocoupler 16 is supplied to the control unit 7 and processed there.

There are also arranged on the fender 3 infrared sensors 6 that output their signals to the control unit 7. The control unit 7 evaluates the infrared spectra of the infrared sensors 6 and calibrates them, if necessary, with the temperature information supplied by the ambient temperature sensor 17. If an infrared sensor 6 now supplies a spectrum that is assigned to an animate object 20, this information is compared with signals from the fiber optic sensor 5. If the fiber optic sensor 5 indicates no deformation, the control unit 7 also does not trigger a signal for raising the engine hood. If an animate object 20 emitting an infrared radiation 8 moves closely past the vehicle without there being deformation of the fiber optic sensor 5, the engine hood remains securely in its original position. As further signal, the control unit 7 can feed the signal of a tachometer 22 for the purpose of lifting the engine hood. The engine speed can also contribute to the decision as to whether the engine hood 2 is to be raised or not.

The accident situation with an animate object 20 is now illustrated in FIG. 5. The leg 18 of a person 9 has been caught by the fender 3, which has been deformed by it. Consequently, the fiber optic sensor 5 has also been deformed by the leg 18 of the person 9, as a result of which the optocoupler 16 receives a light intensity signal and passes it on to the control unit 7, which indicates that the fender 3 has been struck and deformed. Since the object struck is an animate object 20 here, it will emit characteristic infrared radiation 8 that is detected by the infrared sensor 6. The infrared sensors 6 supply the detected spectrum to the control unit 7, which now decides with the aid of the ambient temperature and of the vehicle speed that the engine hood 2 is to be raised because a person 9 has been hit. It is also conceivable not only to decide as to whether the engine hood is to be raised or not, but also how far it must be raised in order to ensure an optimum protection function. The current vehicle speed plays an important role precisely in this connection. The combination of information from the fiber optic sensor 5, the infrared sensors 6, the ambient temperature sensors 17 and the tachometers 22 leads to a reliable decision as to whether and how the object hit is to be protected.

An accident situation with an inanimate object 21 is illustrated in FIG. 6. Here, the fiber optic sensor 5 arranged in the front region 4 of the motor vehicle 1 detects a deformation of the fender 3, but the infrared sensor 6 does not detect an infrared spectrum characteristic of an animate object 20. In this accident situation,: the control unit 7 must decide reliably that the engine hood 2 remain in its original position in order to effectively protect the vehicle occupant 23 against forces occurring during the accident.

1-6. (canceled)

7. A sensor system for detecting a pedestrian collision in the front region (4) of a motor vehicle (1), the sensor system having at least one fiber optic sensor (5) that extends in the front region (4) of the motor vehicle (1) largely over the entire vehicle width (19), which sensor is deformable by the collision of an object (18, 20, 21) in the front region (4), wherein a signal is generated by the fiber optic sensor (5) owing to the collision of the object (18, 20, 21), and wherein, in addition to the fiber optic sensor (5), there is arranged in the front region (4) of the motor vehicle (1) at least one infrared sensor (6) that generates a signal for distinguishing between the collision of animate (18, 20) and inanimate objects (21).

8. The sensor system for detecting a pedestrian collision as claimed in claim 7, wherein the fiber optic sensor (5) is integrated in the front fender (3) of the motor vehicle (1).

9. The sensor system for detecting a pedestrian collision as claimed in claim 7, wherein the infrared sensor (6) is integrated in the front fender (3) of the motor vehicle (1).

10. The sensor system for detecting a pedestrian collision as claimed in claim 7, wherein the signals of the fiber optic sensor (5) and of the infrared sensor (6) are evaluated by a control unit (7).

11. The sensor system for detecting a pedestrian collision as claimed in claim 7, wherein the control unit (7) is also fed signals from a temperature sensor (17) that are evaluated in the control unit (7) in addition to the signals of the fiber optic sensor (5) and of the infrared sensor (6).

12. The sensor system for detecting a pedestrian collision as claimed in claim 7, wherein the control unit (7) is also fed signals from a tachometer (22) that are evaluated in the control unit (7) in addition to the signals of the fiber optic sensor (5), of the infrared sensor (6) and of the temperature sensor (17).
